(19) United States
(12) Patent Application Publication
(10) Pub. No.: US 2017/0248070 A1
(43) Pub. Date: Aug. 31, 2017

(54) TURBOCHARGER WITH INTEGRATED ACTUATOR

(71) Applicant: BorgWarner Inc., Auburn Hills, MI (US)

(72) Inventors: George E. HEDDY, III, Hendersonville, NC (US); Eric JONES, Arden, NC (US); Daniel N. WARD, Asheville, NC (US)

(21) Appl. No.: 15/512,882

(22) PCT Filed: Sep. 11, 2015
(86) PCT No.: PCT/US2015/049550

§ 371 Date: Mar. 21, 2017

Related U.S. Application Data
(60) Provisional application No. 62/054,023, filed on Sep. 23, 2014.

(51) Int. Cl. F02B 37/16; F02B 37/24

(52) U.S. Cl. CPC F02B 37/168; F02B 37/24

(57) ABSTRACT

A turbocharger (1) includes a variable turbine geometry (VTG) device (20) disposed in the turbine housing (11) adjacent to the turbine wheel (4) and configured to selectively control the amount of exhaust gas delivered to the turbine wheel (4). A geared actuating mechanism (40) connects the VTG device (20) to an actuator (30) disposed outside the turbocharger bearing housing (8). The geared actuating mechanism (40) includes an actuation pivot shaft (94) that is rotatably supported in a shaft-receiving bore (25) and connected to the VTG device (20) such that at least a portion of the geared actuating mechanism (40) is disposed externally of the housing (8). A cover (75) surrounds the actuator (30) and the geared actuating mechanism (40), and forms a sealed connection with the housing (8) such that exhaust gas passing into the shaft-receiving bore (25) is prevented from escaping to the atmosphere.

### CROSS-REFERENCE TO RELATED APPLICATION

This application claims priority to and all the benefits of U.S. Provisional Application No. 62/054,023, filed on Sep. 23, 2014, and entitled “Turbocharger With Integrated Actuator.”

### BACKGROUND

Advantages of turbocharging include increased power output, lower fuel consumption, and reduced pollutant emissions. The turbocharging of engines is no longer primarily seen from a high-power performance perspective, but is rather viewed as a means of reducing fuel consumption and environmental pollution on account of lower carbon dioxide (CO₂) emissions. Currently, a primary reason for turbocharging is using exhaust gas energy to reduce fuel consumption and emissions. In turbocharged engines, combustion air is pre-compressed before being supplied to the engine. The engine aspirates the same volume of air-fuel mixture as a naturally aspirated engine, but due to the higher pressure, thus higher density, more air and fuel mass is supplied into a combustion chamber in a controlled manner. Consequently, more fuel can be burned, so that the engine's power output increases relative to the speed and swept volume.

In exhaust gas turbocharging, some of the exhaust gas energy, which would normally be wasted, is used to drive a turbine. The turbine includes a turbine wheel that is mounted on a shaft and is rotatably driven by exhaust gas flow. The turbocharger returns some of this normally wasted exhaust gas energy back into the engine, contributing to the efficiency of the engine and saving fuel. This is achieved via a compressor, which is driven by the turbine and draws in filtered ambient air, compresses the air, and then supplies the compressed air to the engine. The compressor includes a compressor wheel that is mounted on the same shaft so that rotation of the turbine wheel causes rotation of the compressor wheel.

Turbochargers typically include a turbine housing connected to the exhaust manifold of the engine, a compressor housing connected to the intake manifold of the engine, and a center bearing housing coupling the turbine and compressor housings together. The turbine housing defines a volute that surrounds the turbine wheel and that receives exhaust gas from the engine. The turbine wheel in the turbine housing is rotatably driven by a controlled inflow of exhaust gas supplied from the exhaust manifold via the volute.

### SUMMARY

In some aspects, a variable turbine geometry (VTG) turbocharger includes a turbine wheel, a turbine housing that surrounds the turbine wheel and a VTG device disposed in the turbine housing adjacent to the turbine wheel. The VTG device is configured to selectively control the amount of exhaust gas delivered to the turbine wheel. The turbocharger includes a bearing housing defining a shaft-receiving bore and an actuating mechanism configured to connect the VTG device to an actuator. The actuating mechanism includes an actuation pivot shaft that is disposed in the shaft-receiving bore and connected to the VTG device, and at least a portion of the actuating mechanism is disposed externally of the bearing housing. The turbocharger includes the actuator and a cover that surrounds the actuator and the actuating mechanism. The cover forms a sealed connection with the bearing housing such that exhaust gas passing into the shaft-receiving bore is prevented from escaping to the atmosphere.

The turbocharger includes one or more of the following features: The cover comprises an air inlet connected to a source of pressurized air, whereby gas within the area surrounded by the cover is at a higher pressure than atmospheric pressure. The source of pressurized air comprises an air outlet of a compressor section of the turbocharger. The bearing housing comprises a passage that connects the shaft-receiving bore to a lubrication oil drain, whereby pressurized air from within the cover exits the turbocharger via the passage and the oil drain. The shaft-receiving bore includes a first end adjacent the actuating mechanism and a second end adjacent the VTG device, the bearing housing includes a lubrication oil drain and a passage that connects the shaft-receiving bore to the lubrication oil drain, and the passage communicates with the shaft-receiving bore at a location between the first end and the second end. The turbocharger includes piston rings disposed between the actuation pivot shaft and the shaft-receiving bore, and wherein the passage communicates with the shaft-receiving bore at a location between adjacent piston rings. The actuating mechanism comprises interconnecting elements configured to transmit a rotational motion provided by the actuator into a rotational motion of the actuation pivot shaft, and each element of the actuating mechanism comprises a gear-toothed surface, and each element is connected to an adjoining interconnecting element via its respective gear-toothed surface. The cover comprises an air inlet connected to a source of pressurized air, and the turbocharger comprises an air cooler configured to cool air from the source of pressurized air prior to reaching the air inlet, whereby gas within an area surrounded by the cover can be made cooler than an ambient temperature outside the cover.

In some aspects, an actuating assembly is mounted on an outer surface of a housing and is configured to actuate a device located within the housing. The actuating assembly includes an actuator and an actuation pivot shaft that extends through a shaft-receiving bore in the housing. The actuation pivot shaft includes a first end that is disposed on an outside of the housing and is connected to the actuator and a second end disposed on an inside of the housing and connected to the device. The actuating assembly includes an actuating mechanism that connects the actuation pivot shaft to the actuator, and a cover that cooperates with a portion of the outer surface of the housing to form a sealed enclosure that encloses the actuator, the actuating mechanism and the actuation pivot shaft first end.

The actuating assembly includes one or more of the following features: Gas within the sealed enclosure is at a pressure higher than atmospheric pressure. The cover includes an air inlet connected to a source of pressurized air, whereby gas within the sealed enclosure is at a higher pressure than atmospheric pressure. The housing further includes a sink passage formed therein, the sink passage defining a fluid flow path between the shaft-receiving bore and a drain opening formed in the housing at a location not enclosed by the cover. The actuating assembly includes a first seal and a second seal. The first seal includes piston rings disposed between the actuation pivot shaft and the shaft-receiving bore, and the second seal includes a region of relatively low pressure at a location corresponding to a sink passage in the housing, and regions of high pressure provided on opposed sides of the region of relatively low pressure. The actuating mechanism comprises interconnecting elements configured to transmit a rotational motion provided by the actuator into a rotational motion of the actuation pivot shaft, and each element of the actuating mechanism comprises a gear-toothed surface, and each element is connected to an adjoining interconnecting element via its respective gear-toothed surface. The cover comprises an air inlet connected to a source of cooled air, whereby gas within the sealed enclosure is at a cooler temperature than ambient temperature.

VTG turbochargers allow a turbine flow cross-section leading to the turbine wheel to be varied in accordance with engine operating points. This allows the entire exhaust gas energy to be utilized and the turbine flow cross-section to be set optimally for each operating point. As a result, the efficiency of the turbocharger and hence that of the engine can be higher than that achieved with bypass control of a wastegate valve assembly.

In some VTG turbochargers, adjustable guide vanes in the turbine are used to control pressure build-up behavior and, therefore, the turbocharger power output. The adjustable guide vanes are pivotally connected to a lower ring and an upper vane ring, including various possible rings, and/or nozzle wall. The angular position of the guide vanes is adjusted to control exhaust gas backpressure and turbocharger speed by modulating the exhaust gas flow to the turbine wheel. The guide vanes can be pivoted by vane levers, which can be located above the upper vane ring. Performance and flow to the turbine are influenced by changes of the flow angle to the turbine wheel by pivoting the guide vanes.

One goal of VTG turbochargers is to expand the usable flow rate range in practical applications while maintaining a high level of efficiency. To accomplish this, the turbine output is regulated by changing an inflow angle and inflow speed of the exhaust gas flow at a turbine wheel inlet. With VTG turbochargers, this is achieved using guide vanes in front of the turbine wheel that change their angle of attack with exhaust gas flow speed. This reduces lag at slow speeds while opening to prevent exhaust gas backpressure at higher speeds.

With VTG, turbocharger ratios can be altered as conditions change. When the guide vanes are in a closed position, the high circumferential components of the flow speed and a steep enthalpy gradient lead to a high turbine output and therefore to a high charging pressure. When the guide vanes are in a fully open position, the turbine reaches its maximum flow rate and the velocity vector of the flow has a large centripetal component. An advantage of this type of output control over bypass control is that the entire exhaust gas flow is always directed through the turbine and can be converted to output. Adjustments of the guide vanes can be controlled by various pneumatic or electrical actuators.

A VTG turbocharger may have an actuation pivot shaft with a VTG lever to help control the movement of the guide vanes. A VTG actuation pivot shaft is typically not fitted directly to a bore in the turbine housing, but more often to a stationary bearing in a bore in the turbine housing. The actuation pivot shaft is often radially located in a bearing, which can be located either in a bore, with a centerline within the turbine housing, or directly in the bearing housing depending on the design.

The actuation pivot shaft system typically needs sealing between turbine gas pressure and atmospheric pressure. A VTG actuation pivot shaft system is difficult to seal in part because of the clearance between the shaft and bushings. This clearance is necessary with the bushing design to prevent binding, but it creates misalignment of the shaft to the bushing/housing.

The VTG turbocharger includes a VTG device disposed in the turbine housing between the turbine volute and the turbine wheel. The VTG device is configured to selectively control the amount of exhaust gas delivered to the turbine wheel. The VTG device is connected to an actuator disposed outside the turbocharger housing via an actuating mechanism. The actuating mechanism includes an actuation pivot shaft that is rotatably disposed in a shaft-receiving bore formed in the bearing housing. At least a portion of the actuating mechanism is disposed externally of the bearing housing. The turbocharger includes a cover that surrounds the actuator and the actuating mechanism, and forms a sealed connection with the bearing housing such that exhaust gas passing into the shaft-receiving bore is prevented from escaping to the atmosphere.

The VTG actuator and actuating mechanism for the turbocharger are sealed within one or more covers that serve to prevent exhaust gas leakage from the turbocharger housing via the shaft-receiving bore.

The area enclosed by the cover defines an enclosure that is pressurized, for example by using a portion of the charged air generated in the turbocharger compressor. By providing a pressurized enclosure, a flow of air is forced into the joint between the actuation pivot shaft and the bushing that supports the actuation pivot shaft, preventing the pressurized exhaust gas from exiting the turbocharger housing at this location.

The pressurized air delivered to the cover is conditioned using an air-to-air cooler, a filter and/or a pressure regulator. The cooled air cools the actuator, the VTG actuating mechanism and the turbine end of the bearing housing, minimizing heat related damage to these parts and coking at the turbine end. In this regard, when the actuator includes electronics, such electronics can be sensitive to high temperatures, whereby cooling the actuator can improve actuator accuracy and durability.

An exhaust gas passage is formed in the bearing housing. One end of the exhaust gas passage opens facing the actuation pivot shaft, and an opposed end of the exhaust gas passage opens to a drain for lubrication oil. The drain returns oil to the engine crankcase, where the leakage enters the engine air inlet and is burned. Thus by retaining the leaked exhaust gas within the bearing housing and using pressure to direct the leaked exhaust gas to the engine crankcase via the exhaust passage and drain, leakage from the actuation pivot shaft is minimized or eliminated.

The exhaust passage includes radially-extending through holes formed in the sidewall of the bushing that supports the actuation pivot shaft within the housing, and a radial bore formed in the bearing housing, the radial bore providing fluid communication between the radial bores of the bushing and the drain via a half-moon shaped sump formed in the bore.

The actuator is disposed outside the turbocharger and includes a geared output shaft. In addition, the VTG actuating mechanism may include a series of gears that connect the geared output shaft of the actuator to a geared actuation pivot shaft connected to the VTG device. The geared connection between the actuator and the VTG device advantageously decreases hysteresis, improves accuracy of the kinematics, and reduces wear.

This configuration addresses many problems associated with some conventional turbocharger VTG actuating mechanisms in which the actuator is connected to the VTG device via a lever arm and linkages. For example, when assembling a conventional VTG lever arm to the actuation pivot shaft, in some cases the actuator is manually rotated in order to tighten a pinch bolt through a small “window,” whereby the actuator can be damaged during assembly. In another example, although the actuation pivot shaft may have piston rings to reduce soot leakage from the shaft-receiving bore, some exhaust gas is still vented to the atmosphere via the shaft-receiving bore. In another example, forming the connection between the actuator and the actuator lever arm is often done in a swaging (e.g., cold forging) process, but this process can create cracks in the actuator lever arm and/or damage the actuator. In another example, the fork-style actuation pivot shaft used in some conventional VTG actuating mechanisms moves a block attached to a pin. This combination of components accrues tolerances, reducing accuracy. In another example, in order to address customer requirements including tolerance of higher temperatures and reduction in turbocharger size, the materials used to form the race of the conventional linkage are relatively expensive. In still another example, the conventional linkage is assembled using a hex tool on the back side of a ball stud, which can difficult to perform in the tight spaces provided. By providing a geared actuator that rotates a series of gears attached to a geared actuation pivot shaft, use of an expensive linkage is avoided and assembly is simplified. In addition, the geared VTG actuating mechanism is capable of tolerating higher temperatures, and results in lower vane angle tolerances, reduced wear, and lower hysteresis relative to some conventional VTG actuating mechanisms.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a cross sectional view of a VTG turbocharger;

FIG. 2 is a side perspective view of the VTG turbocharger of FIG. 1 with the turbine housing and cover omitted for clarity;

FIG. 3 is a schematic diagram of fluid flow within an engine system that includes the VTG turbocharger of FIG. 1;

FIG. 4 is an enlargement of a portion of the cross sectional view of the VTG turbocharger shown in FIG. 1;

FIG. 5 is a cross-sectional view of the VTG turbocharger as seen along line 5-5 of FIG. 4;

FIG. 6 is a side perspective view of a VTG turbocharger including an alternative actuation mechanism, with a portion of the cover removed to show the alternative actuation mechanism, and the turbine housing removed for clarity;

FIG. 7 is a side perspective view of the VTG turbocharger of FIG. 5 with the cover in place over the alternative actuation mechanism; and

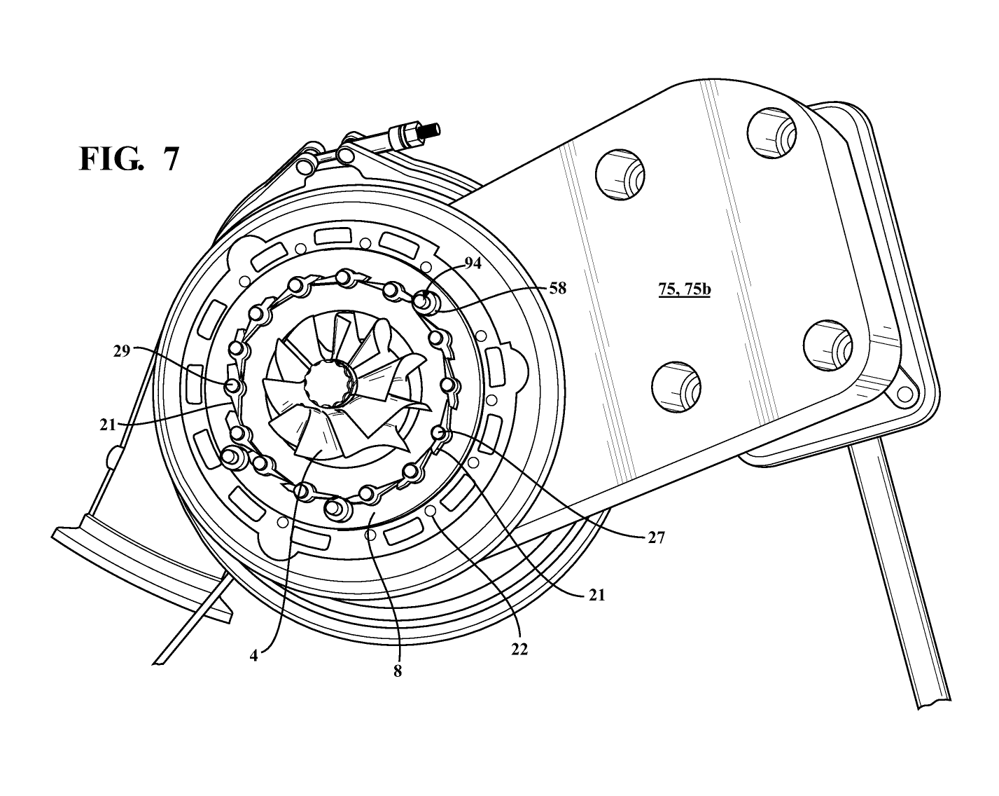

FIG. 8 illustrates an alternative cover configuration.

### DETAILED DESCRIPTION

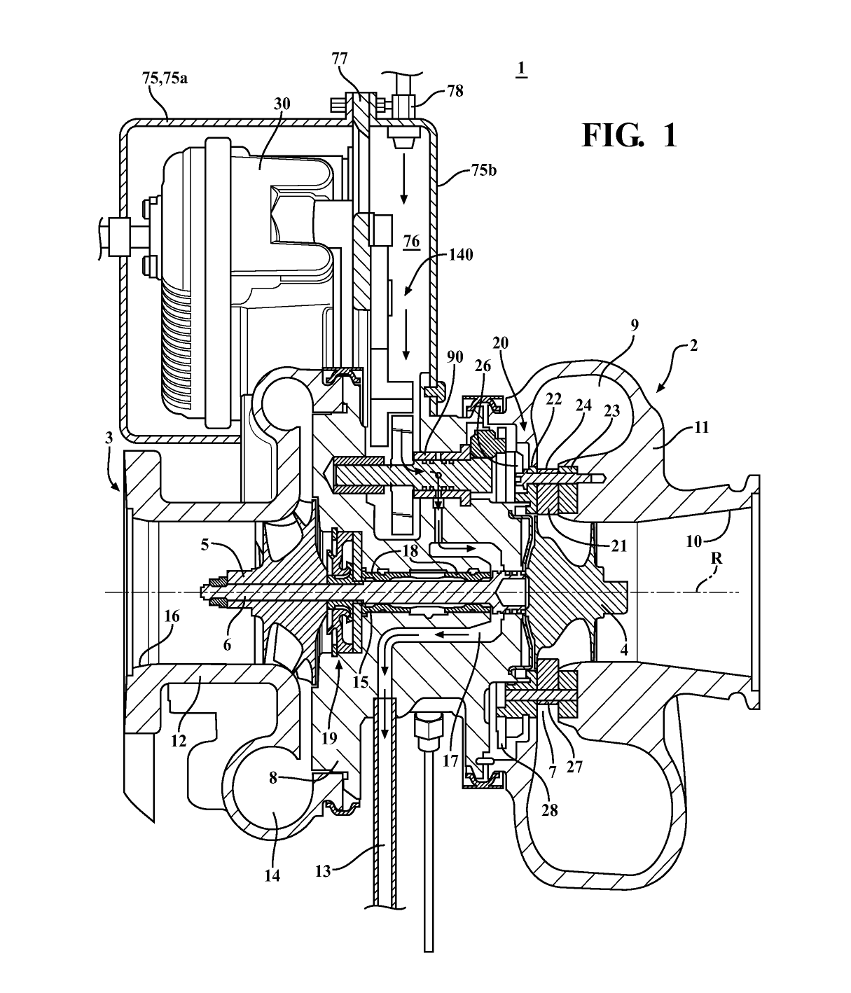

Referring to FIGS. 1-3, an exhaust gas turbocharger 1 includes a turbine section 2, a compressor section 3, and a center bearing housing 8 disposed between and connecting the compressor section 3 to the turbine section 2. The turbine section 2 includes a turbine housing 11 that defines an exhaust gas inlet (not shown), an exhaust gas outlet 10, and a turbine volute 9 disposed in the fluid path between the exhaust gas inlet and exhaust gas outlet 10. A VTG device 20 including adjustable guide vanes 21 is located inside a radially-extending throat 7 of the turbine volute 9. A turbine wheel 4 is disposed in the turbine housing 11 between the throat 7 and the exhaust gas outlet 10.

The compressor section 3 includes a compressor housing 12 that defines the air inlet 16, an air outlet (not shown), and a compressor volute 14. A compressor wheel 5 is disposed in the compressor housing 12 between the air inlet 16 and the compressor volute 14. The compressor wheel 5 is connected to the turbine wheel 4 via a main shaft 6.

The main shaft 6 is supported for rotation about a rotational axis R within an axially-extending bore 15 in the bearing housing 8 via a pair of axially spaced journal bearings 18. In addition, a thrust bearing assembly 19 is disposed in the bearing housing 8 so as to provide axial support for the main shaft 6.

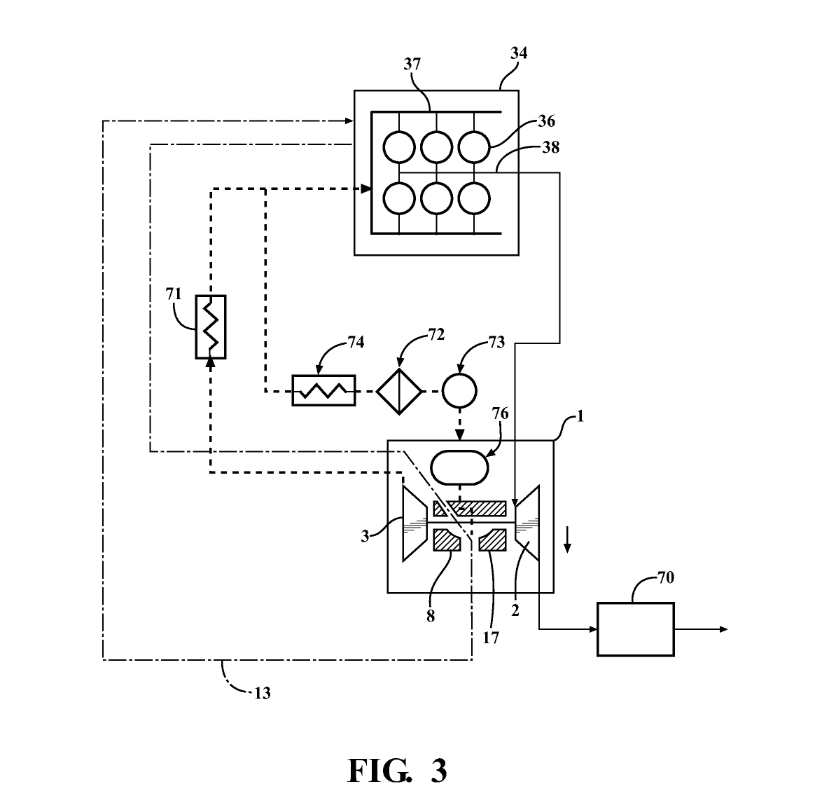

In use, the turbine wheel 4 in the turbine housing 11 is rotatably driven by an inflow of exhaust gas supplied from an exhaust manifold 38 of an engine 34 (FIG. 3). Since the main shaft 6 is rotatably supported in the center bearing housing 8 and connects the turbine wheel 4 to the compressor wheel 5 in the compressor housing 12, the rotation of the turbine wheel 4 causes rotation of the compressor wheel 5. As the compressor wheel 5 rotates, the air mass flow rate increases, airflow density and air pressure delivered to the cylinders 36 of the engine 34 via an outflow from the compressor air outlet (not shown), which is connected to an air intake manifold 37 of the engine 34.

The VTG device 20 includes guide vanes 21 that are pivotably supported between an upper vane ring 22 and lower vane ring 23, which are spaced apart by spacers 24. The guide vanes 21 are adjustable through an actuator 30 which actuates an adjustment ring 26. A rotary motion of the adjustment ring 26 about the rotational axis R with respect to the upper vane ring 22 is transmitted onto the guide vanes 21, which by this device can be adjusted within a pre-determined range between the open and closed positions. The spacing between the guide vanes 21 defines the flow channels of the circular throat 7 in which the exhaust gas radially flows toward the turbine wheel 4. The flow channels are adjustable through variation of the angular position of the guide vanes 21.

More specifically, the guide vanes 21 are mounted to the upper vane ring 22 by means of vane shafts 27, which penetrate the upper vane ring 22 and which carry a vane arm 28 on the end opposing the guide vanes 21. The adjustment ring 26 is located in a vacancy between the bearing housing 8 and the turbine housing 11 so as to be disposed within the axial plane of the circularly-arranged vane arms 28. The adjustment ring 26 engages each of the vane arms 28 such that during rotation of the adjustment ring 26 with respect to the upper vane ring 22, all vane arms 28, and therewith the guide vanes 21, are simultaneously rotated.

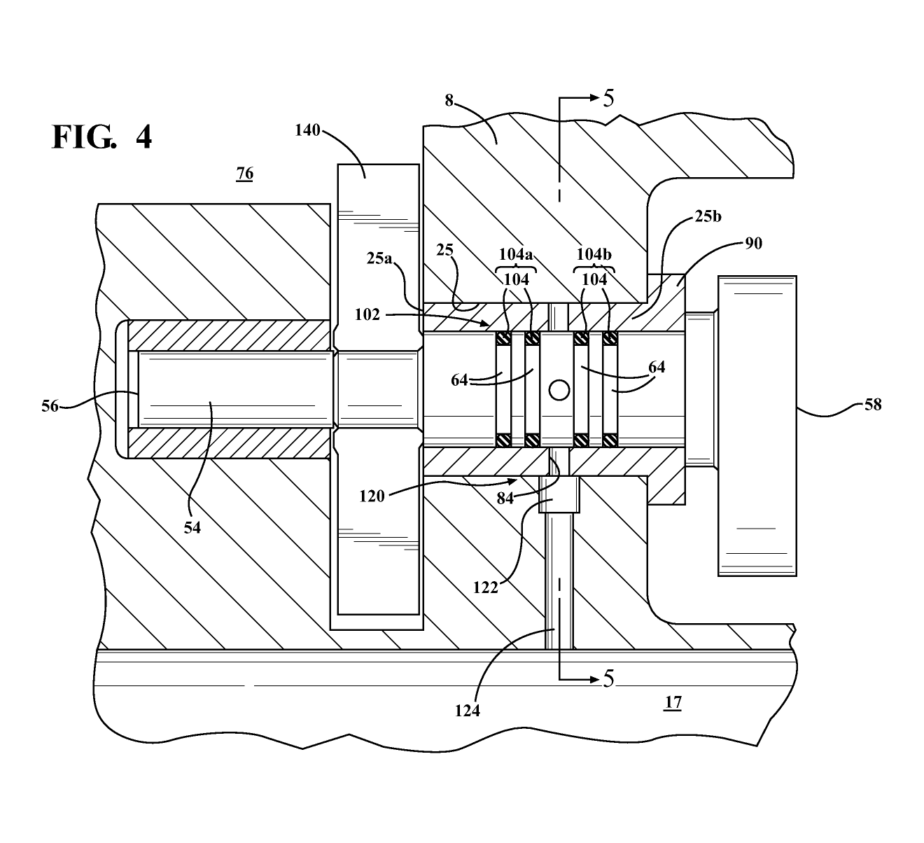

As illustrated in FIG. 4, the adjustment ring 26 is connected to the actuator 30 via an actuating mechanism 140 that transfers a rotational motion output from the actuator 30 to the adjustment ring 26. The actuator 30 that drives the VTG device 20 is secured to an outer surface of the bearing housing 8, for example via a bracket (not shown). The actuating mechanism 140 includes an actuation pivot shaft 54 that enables the adjustment of the adjustment ring 26 from outside of the bearing housing 8. To this end, the actuation pivot shaft 54 is rotatably supported and radially located within a shaft-receiving bore 25 formed in the bearing housing 8 via a bushing 90 that is press fit into the shaft-receiving bore 25. In the illustrated embodiment, the actuation pivot shaft 54 and the bushing 90 are disposed in the shaft-receiving bore 25. The shaft-receiving bore 25 extends through a wall portion of the bearing housing 8 and includes first and second bore openings 25a, 25b, respectively. In some turbocharger designs, the shaft-receiving bore 25 may be formed at least partially within the turbine housing 11.

The actuation pivot shaft 54 protrudes through the first and second bore openings 25a, 25b in the bearing housing 8 so that a first end 56 of the actuation pivot shaft 54 engages the VTG actuating mechanism 140 on an outside of the bearing housing 8 at a location that, in some conventional turbocharger designs, is at atmospheric pressure. In addition, an opposed, second end 58 of the actuation pivot shaft 54 engages the VTG device 20 within the bearing housing 8 at location that is at a relatively high pressure corresponding to the pressure of the exhaust gas.

Three seals 75, 102 and 120 can be used individually, or in combination, to address leakage of exhaust gas out of the bearing housing 8 via the shaft-receiving bore 25. For example, a first seal, such as a labyrinth seal 102, may be disposed between the actuation pivot shaft 54 and the bushing 90. The labyrinth seal 102 includes piston rings 104, which are received in corresponding axially-spaced circumferential grooves 64 formed in an outer surface of the actuation pivot shaft 54. Four piston rings 104 are employed between the actuation pivot shaft 54 and the bushing 90. The piston rings 104 are arranged in two piston ring pairs 104a, 104b.

A second seal can surround a portion of the outside of the bearing housing 8 in the vicinity of the first bore opening 25a of the shaft-receiving bore 25 to the outside. The second seal may be, for example, a cover 75 that prevents the escape of exhaust gas from the exhaust (70) into the environment. The cover 75 is sealed to, and cooperates with, a portion of the outer surface of the bearing housing 8 to form a sealed enclosure 76 that encloses the actuator 30, the actuating mechanism 140 and the actuation pivot shaft first end 56. This configuration minimizes or eliminates leakage of exhaust gas out of the bearing housing 8 via the shaft-receiving bore 25.

In the illustrated embodiment, the cover 75 includes two cover portions 75a, 75b that are bolted together along a sealed joint (77) and cooperate with, and are sealed to, the bearing housing 8 to form the sealed enclosure 76. The cover 75 includes a cover air inlet 78 connected to a source of pressurized air, whereby gas within the sealed enclosure 76 is at a higher pressure than atmospheric pressure. In the illustrated embodiment, the source of pressurized air is pressurized air generated in the compressor section 3 of the turbocharger 1, but the source is not limited to this.

Referring to FIG. 3, the air delivered to the enclosure 76 may be conditioned. For example, prior to reaching the cover air inlet 78 (FIG. 1), the air may pass through an air-to-air cooler 74 located downstream of a conventional charged air cooler 71, an air filter 72 and/or a pressure regulator 73. As a result, the air delivered to the enclosure 76 is clean, cooled and at a pre-determined pressure that is greater than atmospheric pressure. The air-to-air cooler 74 is configured to cool the delivered air prior to reaching the cover air inlet 78, whereby the air within the enclosure 76 is cooled. For example, the air within the enclosure 76 can be made cooler than the ambient temperature (e.g, the air temperature outside the cover 75). The pressure regulator 73 controls the air pressure within the enclosure 76. Pressure in the enclosure 76 will vary depending on the application. For example, the pressure in the enclosure 76 may be set between 1.05 to 3.0 atmospheres. In some embodiments, the air delivered to the enclosure 76 may be set to be at least seventy-five percent of the exhaust gas pressure within the turbine volute 9. For example, when the exhaust gas pressure within the turbine volute 9 is 4 atmospheres, the pressure regulator 73 provides air to the enclosure 76 at a pressure of 3 atmospheres. Pressurization of the enclosure 76 may also reduce or prevent fouling of the actuator 30 and the actuating mechanism 40 due to exhaust gas leakage from the shaft-receiving bore 25.

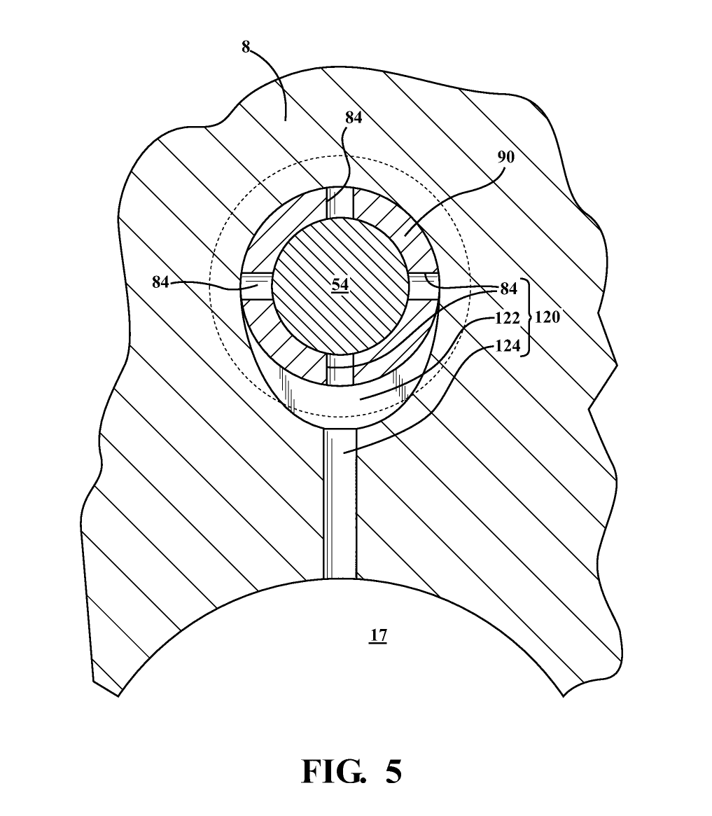

Referring again to FIG. 4, and as illustrated in FIG. 5, a third seal may be disposed in the shaft-receiving bore 25 between the bushing 90 and a surface of the shaft-receiving bore 25 (e.g., the bearing housing 8). The third seal may be, for example, a sink seal 120 that prevents exhaust gas from entering the enclosure 76, and instead directs exhaust gas passing through the shaft-receiving bore 25 to the crankcase 35 (not shown) of the engine 34 via an oil lubrication passageway 17 (shown in FIGS. 1 and 3) of the bearing housing 8 and corresponding oil lubrication drain line 13 (shown in FIGS. 1 and 3). The sink seal 120 includes a sump 122 formed in a surface of the shaft-receiving bore 25 at a location spaced apart from the first and second bore openings 25a, 25b. In the illustrated embodiment, the sump 122 is disposed between two pairs of piston rings 104a, 104b, such that a labyrinth seal is provided between the sump 122 and each first or second bore opening 25a, 25b, respectively. In the illustrated embodiment, the sump 122 is a hemispherical depression disposed on a downward-facing side of the shaft-receiving bore 25. In other embodiments, the sump 122 may be a circumferentially-extending channel that surrounds the outer surface of the bushing 90.

As illustrated in FIG. 5, the bushing 90 includes radially-extending cross-drilled through-holes 84 which allow the pressurized air from the enclosure 76 to mix with the pressurized exhaust gas leaking from the turbine housing 11. The through-holes 84 are equidistantly spaced about a circumference of the bushing 90, and are axially positioned so as to communicate with the sump 122, where the pressurized air and exhaust gas mix further. In the illustrated embodiment, there are four through-holes 84 arranged to lie in a common plane, but the through-holes are not limited to this number or arrangement.

The sink seal 120 also includes a generally radially-extending sink passageway 124 formed in the bearing housing 8 having one end that communicates with the sump 122, and an opposed end that communicates with the oil lubrication passageway 17 of the bearing housing 8. This arrangement permits the mixed air and exhaust gas within the sump 122 to “drain” into the turbocharger oil lubrication drain line 13.

As used herein, the term “sink seal” refers to the condition in which the sink passageway 124, the oil lubrication passageway 17 and oil lubrication drain line 13 are at substantially atmospheric pressure, and in which this region of atmospheric pressure is disposed between the first relatively higher pressure region (e.g. greater than atmospheric pressure) within the enclosure 76 at the first bore opening 25a, and the second relatively higher pressure region (e.g. greater than atmospheric pressure) within the turbine housing 11 at the second bore opening 25b. By locating the sump 122 and sink passageway 124 between the regions of higher pressure, the mixed air and exhaust gas within the sump 122 is directed to the oil lubrication drain line 13, and then ultimately to the engine crankcase 35 (not shown) where it is burned within the engine cylinders 36. Thus the sink seal 120 directs leaked exhaust gas to the engine before it can exit from the second bore opening 25a.

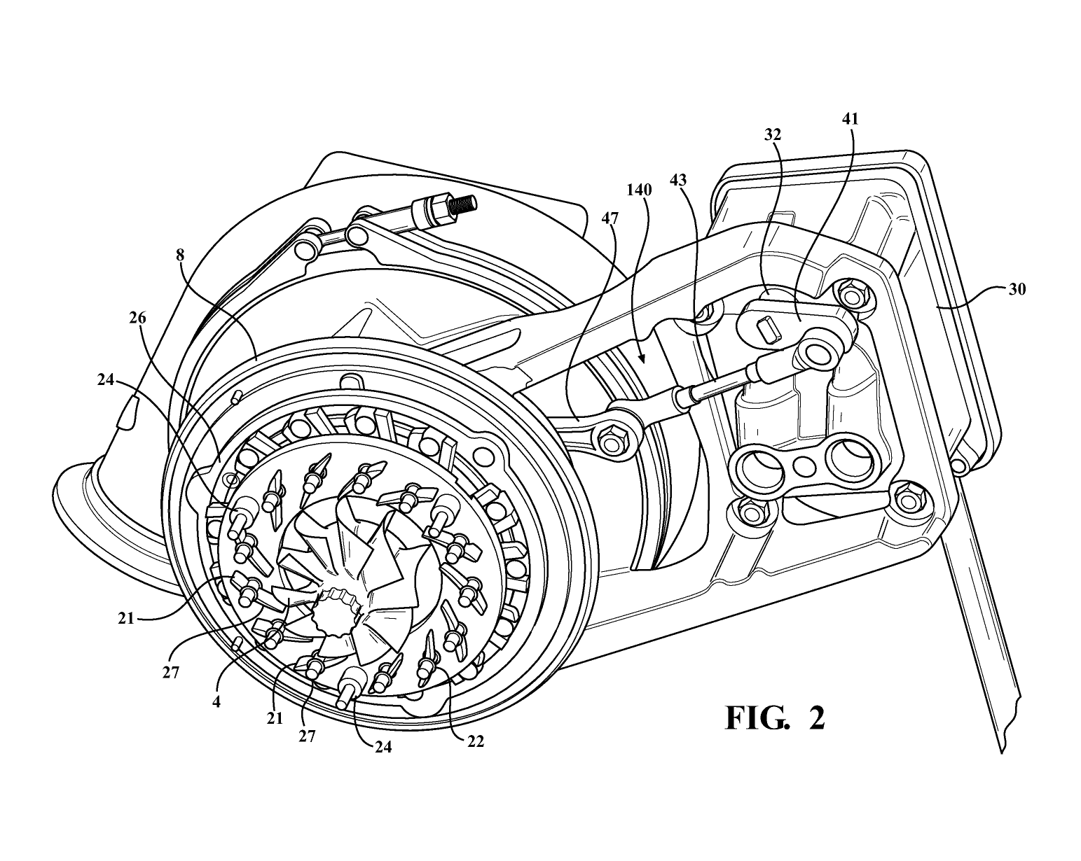

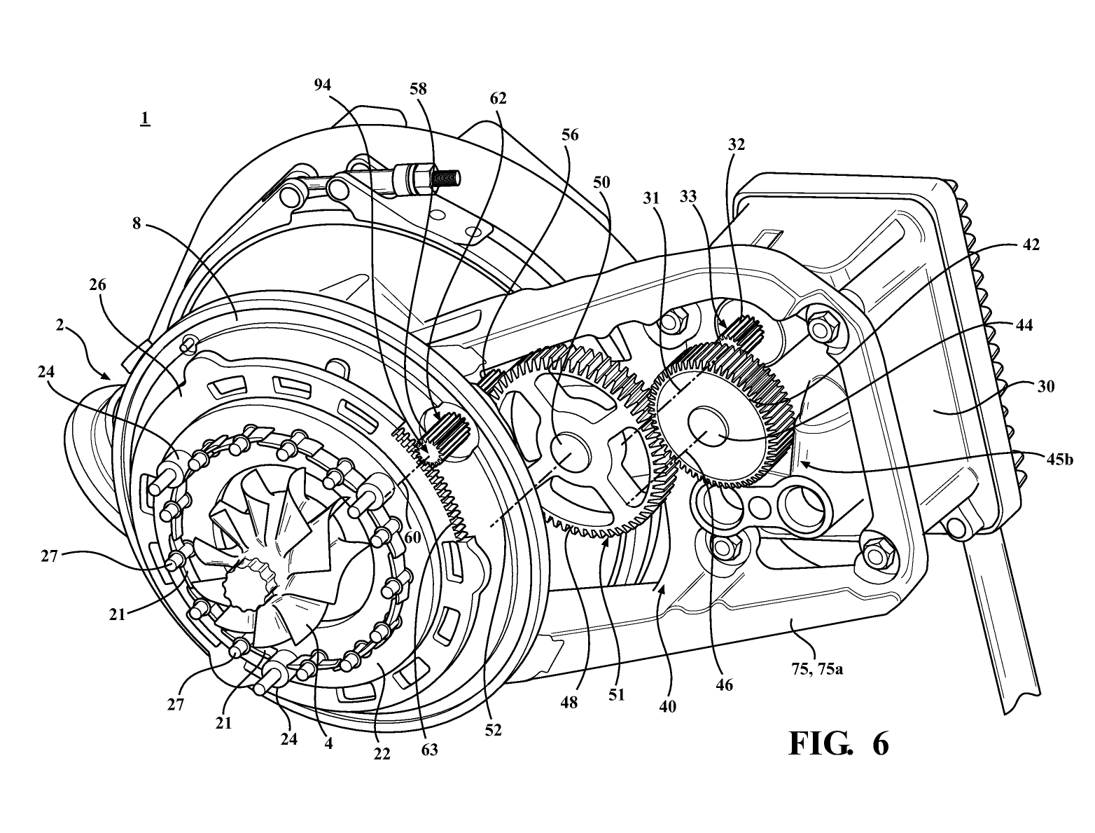

Referring to FIGS. 2 and 6, although the actuator 30 may be connected to the VTG device 20 via a conventional actuating mechanism 140 that includes a VTG lever arm 47, a linkage 43 and an actuation lever arm 41 (FIG. 2), the turbocharger 1 can optionally include an improved geared actuating mechanism 40. The geared actuating mechanism 40 consists of a series of interconnecting elements 42, 48, 94 that are configured to transmit a rotational motion provided by the actuator 30 into a rotational motion of the adjustment ring 26 of the VTG device 20.

In particular, each interconnecting element 42, 48, 94 of the geared actuating mechanism 40 includes a gear-toothed surface, whereby adjacent interconnecting elements 42, 48, 94 are connected to an adjoining interconnecting element 42, 48, 94 via its respective gear-toothed surface. To this end, the outer surface of an output shaft 32 of the actuator 30 is formed having gear teeth 33, whereby the output shaft 32 serves as a drive gear for the geared actuating mechanism 40. One interconnecting element of the geared actuating mechanism 40 may include a first idler gear 42 rotatably supported on a first axle 44. The first idler gear 42 includes both internal and external gear teeth. For example, the first idler gear 42 has inner gear teeth 45a (not shown) formed on a radially inward-facing edge thereof that engage the gear teeth 33 of the output shaft 32 of the actuator 30, whereby the first idler gear 42 is driven by the actuator 30. In addition, the first idler gear 42 has outer gear teeth 45b formed on a radially outward-facing edge thereof. Another interconnecting element of the geared actuating mechanism 40 may include a second idler gear 48 rotatably supported on a second axle 50 and having gear teeth 51 formed on an outer peripheral edge thereof. The gear teeth 51 of the second idler gear 48 engages the outer gear teeth 45b of the first idler gear 42, whereby the second idler gear 48 is driven by the first idler gear 42. Gear teeth 51 of the second idler gear 48 engages gear teeth 62 formed on an outer surface of the remaining interconnecting element 94, whereby the remaining interconnecting element 94 is driven by the second idler gear 48. Interconnecting element 94, may also be, for example, an actuation pivot shaft 94. The only difference between actuation pivot shaft 94 and actuation pivot shaft 54 is that actuation pivot shaft 94 may include gear teeth 62. Gear teeth 62 of the actuation pivot shaft 94 engage teeth 63 formed on an outer portion of the adjustment ring 26 to drive the adjustment ring 26. The rotational axis 31 of the actuator output shaft 32, the rotational axis 46 of the first axle 44, the rotational axis 52 of the second axle 50, and the rotational axis 60 of the actuation pivot shaft 94 are each parallel to the rotational axis R of the main shaft 6.

By providing a geared actuator 30 that drives a series of idler gears 42, 48 attached to the geared actuation pivot shaft 94, the cost of manufacturing the actuating mechanism 40 is reduced and assembly is simplified relative to some conventional configurations. In addition, the geared actuating mechanism 40 is capable of tolerating higher temperatures, and results in lower vane angle tolerances, reduced wear, and lower hysteresis relative to some conventional actuating mechanisms.

Referring to FIG. 6, although the geared actuating mechanism 40 can be used without the cover 75, it is contemplated that the geared actuating mechanism 40 will be enclosed within the cover 75 to minimize or eliminate leakage of exhaust gas out of the bearing housing 8 via the shaft-receiving bore 25. As previously described, the cover 75 is sealed to, and cooperates with, a portion of the outer surface of the bearing housing 8 to form the sealed enclosure 76 that encloses the actuator 30, the actuating mechanism 40 and the actuation pivot shaft first end 56. This configuration minimizes or eliminates leakage of exhaust gas out of the bearing housing 8 via the shaft-receiving bore 25.

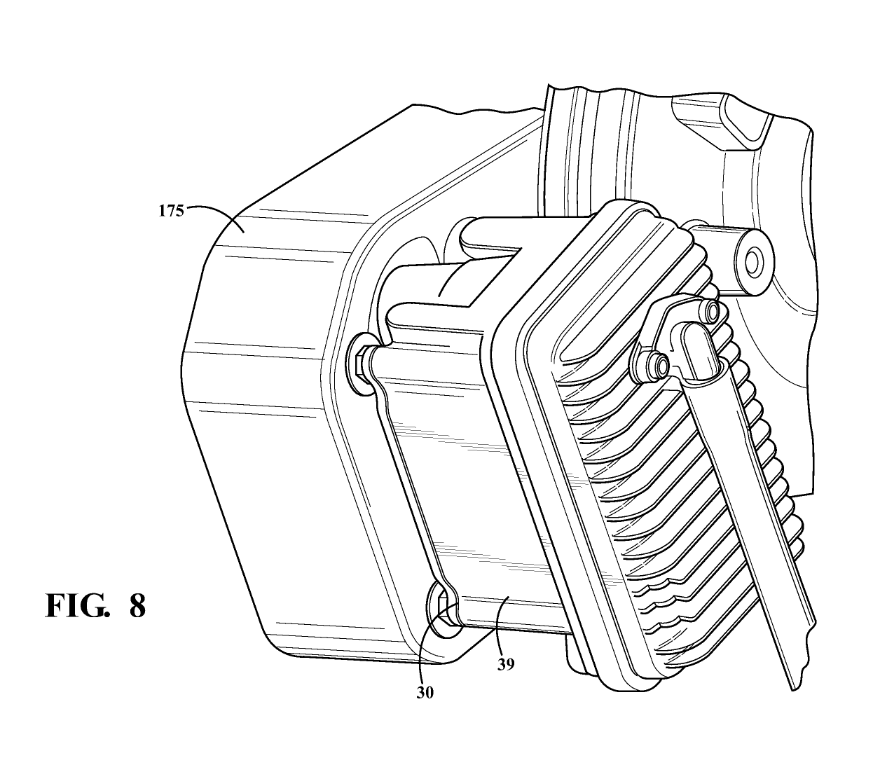

Referring to FIG. 8, in another embodiment, an alternative cover 175 is sealed to, and cooperates with, a portion of the outer surface of the bearing housing 8 to form a sealed enclosure 176 (not shown) that encloses the actuating mechanism 40 and the actuation pivot shaft first end 56. In this embodiment, the actuator 30 is provided in a sealed housing 39, which is then joined in a sealed manner to an outside surface of the alternative cover 175.

Selected illustrative embodiments are described above in some detail. It should be understood that only structures considered necessary for clarifying the illustrative embodiments have been described herein. Other conventional structures, and those of ancillary and auxiliary components of the system, are assumed to be known and understood by those skilled in the art. Moreover, while working examples have been described above, the present disclosure is not limited to the working examples described above, and various design alterations may be carried out without departing from the disclosure as set forth in the claims.

What is claimed is:

1. A variable turbine geometry (VTG) turbocharger (1) comprising
a turbine wheel (4);
a turbine housing (11) that surrounds the turbine wheel (4);
a VTG device (20) disposed in the turbine housing (11) adjacent to the turbine wheel (4), the VTG device (20) configured to selectively control the amount of exhaust gas delivered to the turbine wheel (4);
a bearing housing (8) defining a shaft-receiving bore (25);
an actuating mechanism (40, 140) configured to connect the VTG device (20) to an actuator (30), the actuating mechanism (40, 140) comprising an actuation pivot shaft (54, 94) that is disposed in the shaft-receiving bore (25) and connected to the VTG device (20), at least a portion of the actuating mechanism (40, 140) disposed externally of the bearing housing (8);
the actuator (30); and
a cover (75) that surrounds the actuator (30) and the actuating mechanism (140), and forms a sealed connection with the bearing housing (8) such that exhaust gas passing into the shaft-receiving bore (25) is prevented from escaping to the atmosphere.

2. The turbocharger (1) of claim 1 wherein the cover (75) comprises an air inlet (78) connected to a source of pressurized air, whereby gas within the area surrounded by the cover (75) is at a higher pressure than atmospheric pressure.

3. The turbocharger (1) of claim 2, wherein the source of pressurized air comprises an air outlet of a compressor section (3) of the turbocharger (1).

4. The turbocharger (1) of claim 2, wherein the bearing housing (8) comprises a passage (124) that connects the shaft-receiving bore (25) to an oil lubrication drain (17, 13), whereby pressurized air from within the cover (75) exits the turbocharger (1) via the passage (124) and the oil lubrication drain (17, 13).

5. The turbocharger (1) of claim 1, wherein
the shaft-receiving bore (25) includes a first end (56) adjacent the actuating mechanism (40, 140) and an opposed second end (58) adjacent the VTG device (20),
the bearing housing (8) comprises an oil lubrication drain (17, 13) and a passage (124) that connects the shaft-receiving bore (25) to the oil lubrication drain (17, 13), and
the passage (124) communicates with the shaft-receiving bore (25) at a location between the first end (56) and the opposed second end (58).

6. The turbocharger (1) of claim 5, comprising piston rings (104) disposed between the actuation pivot shaft (54, 94) and the shaft-receiving bore (25), and wherein the passage (124) communicates with the shaft-receiving bore (25) at a location between adjacent piston rings (104).

7. The turbocharger (1) of claim 1 wherein the actuating mechanism (40) comprises interconnecting elements (42, 48, 94) configured to transmit a rotational motion provided by the actuator (30) into a rotational motion of the VTG device (20), and each interconnecting element (42, 48, 94) of the actuating mechanism (40) comprises a gear-toothed surface, and each interconnecting element (42, 48, 94) is connected to an adjoining interconnecting element (42, 48, 94) via its respective gear-toothed surface.

8. The turbocharger (1) of claim 1 wherein
the cover (75) comprises an air inlet (78) connected to a source of pressurized air, and
the turbocharger (1) comprises an air cooler (74) configured to cool air from the source of pressurized air prior to reaching the air inlet (78), whereby gas within an area surrounded by the cover (75) can be made cooler than an ambient temperature outside the cover (75).

9. An actuating assembly (30, 40, 140) mounted on an outer surface of a housing (11) and configured to actuate a device (20) located within the housing (11), the actuating assembly (30, 40, 140) comprising
an actuator (30);
an actuation pivot shaft (54, 94) that extends through a shaft-receiving bore (25) in the housing, the actuation pivot shaft (54, 94) including a first end (56) that is disposed on an outside of the housing (11) and is connected to the actuator (30) and a second end (58) disposed on an inside of the housing (11) and connected to the device (20);
an actuating mechanism (40, 140) that connects the actuation pivot shaft (54, 94) to the actuator (30); and
a cover (75) that cooperates with a portion of the outer surface of the housing (11) to form a sealed enclosure (76) that encloses the actuator (30), the actuating mechanism (40, 140) and the actuation pivot shaft first end (56).

10. The actuating assembly (30, 40, 140) of claim 9, wherein gas within the sealed enclosure (76) is at a pressure higher than atmospheric pressure.

11. The actuating assembly (30, 40, 140) of claim 9, wherein the cover (75) comprises an air inlet (78) connected to a source of pressurized air, whereby gas within the sealed enclosure (76) is at a higher pressure than atmospheric pressure.

12. The actuating assembly (30, 40, 140) of claim 9, wherein the housing (11) further comprises a sink passage (124) formed therein, the sink passage (124) defining a fluid flow path between the shaft-receiving bore (25) and a drain opening (13, 17) formed in the housing at a location not enclosed by the cover (75).

13. The actuating assembly of claim 9, comprising a first seal (102) and a second seal (120), wherein
the first seal (102) includes piston rings (104) disposed between the actuation pivot shaft (54, 94) and the shaft-receiving bore (25), and
the second seal (120) includes a region of relatively low pressure at a location corresponding to a sink passage (124) in the housing, and regions of high pressure provided on opposed sides of the region of relatively low pressure.

14. The actuating assembly of claim 9 wherein the actuating mechanism (40) comprises interconnecting elements (42, 48, 94) configured to transmit a rotational motion provided by the actuator (30) into a rotational motion of the device (20), and each interconnecting element (42, 48, 94) of the actuating mechanism (40) comprises a gear-toothed surface, and each interconnecting element (42, 48, 94) is connected to an adjoining interconnecting element (42, 48, 94) via its respective gear-toothed surface.

15. The actuating assembly of claim 9, wherein the cover (75) comprises an air inlet (78) connected to a source of cooled air, whereby gas within the sealed enclosure (76) is at a cooler temperature than ambient temperature.
